(19) United States
(12) Patent Application Publication
(10) Pub. No.: US 2025/0168909 A1
(43) Pub. Date: May 22, 2025

(54) RADIO TERMINAL AND METHOD THEREFOR

(71) Applicant: NEC Carparation, Minato-ku,Tokyo (JP)

(72) Inventor: Satoaki HAYASHI, Tokyo (JP)

(73) Assignee: NEC Corparation, Minato-ku, Tokyo (JP)

(21) Appl. No.: 18/840,574

(22) PCT Filed: Feb. 8, 2023
(86) PCT No.: PCT/JP2023/004109

§ 371 Date: Aug. 22, 2024

(30) Foreign Application Priority Data
Mar. 11, 2022 (JP) 2022-038087

(51) Int. Cl. H04W 76/14; H04W 12/50; H04W 76/20; H04W 92/18

(52) U.S. Cl. CPC H04W 76/14; H04W 12/50; H04W 76/20; H04W 92/18

(57) ABSTRACT

A radio terminal (1A) performs sidelink communication with a peer radio terminal (1B) on a primary carrier and a secondary carrier. The radio terminal (1A) uses the primary carrier without using the secondary carrier to transmit control plane data belonging to a first type of sidelink signaling radio bearer and control plane data belonging to a second type of sidelink signaling radio bearer. This can help, for example, to enable a radio terminal to transmit control plane data for one or more signaling radio bearers on a particular carrier during a sidelink communication using multiple carriers.

### TECHNICAL FIELD

The present disclosure relates to direct communication between radio terminals (device-to-device (D2D) communication), in particular to the use of multiple carriers in direct communication.

### BACKGROUND ART

The mode in which a radio terminal communicates directly with another radio terminal, without the need for an infrastructure network such as a base station, is commonly referred to as device-to-device (D2D) communication. D2D communications can be integrated with or assisted by a cellular network. Proximity-based services (ProSe), specified in the Third Generation Partnership Project (3GPP (registered trademark)) Release 12 and beyond, provide a system architecture for D2D communications assisted by a cellular network. In addition, cellular Vehicle-to-Everything (V2X) services, specified in 3GPP Release 14 and beyond, refer to ProSe and use D2D communications between radio terminals. D2D communications assisted by a cellular network can also be used for other applications and services (e.g., public safety applications) in addition to V2X services.

The interface between 3GPP radio terminals (i.e., User Equipments (UEs)) used in the control and user planes for D2D communication is called the PC5 interface (or reference point). D2D communication over the PC5 interface is referred to as sidelink communication. The PC5 interface can be based on the Evolved Universal Terrestrial Radio Access (E-UTRA) sidelink capability and can also be based on the 5G New Radio (NR) sidelink capability. D2D (or sidelink) communication over the E-UTRA-PC5 (or Long Term Evolution (LTE)-based PC5) interface is connectionless, i.e., broadcast mode at the Access Stratum (AS) layer. In contrast, sidelink communication over the NR PC5 interface supports unicast mode, groupcast mode, and broadcast mode at the AS layer.

Sidelink communication over the E-UTRA-PC5 interface is referred to, for example, as LTE sidelink communication. Sidelink communication over the NR PC5 interface is referred to, for example, as NR sidelink communication. The 3GPP specification specifies architectural enhancements to facilitate vehicular communications for cellular V2X services (see, for example, Non-Patent Literature 1, 2, and 3). LTE sidelink and NR sidelink communications play an important role in enabling cellular V2X communications. V2X communication over the E-UTRA-PC5 interface, or AS functionality using E-UTRA technology including LTE sidelink communication to enable V2X communication between UEs is referred to as V2X sidelink communication or LTE V2X sidelink communication. V2X communication over the NR PC5 interface, or AS functionality using NR technology including NR sidelink communication to enable V2X communication between UEs is referred to as NR V2X sidelink communication or simply NR sidelink communication.

3GPP Release 15 supports carrier aggregation (CA) and multicarrier operation for LTE sidelink communications (see Non-Patent Literature 1 and 4). For 3GPP Release 18, the 3GPP plans to discuss Sidelink Evolution. This includes support for carrier aggregation for NR sidelink communications and support for sidelink over unlicensed spectrum (see Non-Patent Literature 5).

Patent Literature 1, 2, and 3 disclose sidelink (SL) carrier aggregation, i.e., carrier aggregation for SL communications, and in particular, signaling between UEs and signaling between a UE and a radio access network (e.g., base station) for SL carrier aggregation.

Patent Literature 1 describes that a UE may send to a peer UE an SL carrier aggregation configuration related to the addition, release or modification of a secondary SL (see, for example, FIGS. 3, 4, 5, and 10 in Patent Literature 1). The SL carrier aggregation configuration may be related to the addition, release, or modification of a secondary SL and may include a set of carrier frequencies and deactivation timer information. The SL carrier aggregation configuration may include a reception (Rx) or transmission (Tx) indicator, a primary or secondary SL indicator, a type of carrier aggregation (e.g., data replication or data split), a V2X service type, a synchronization type, a primary SL index (or carrier index), a secondary SL index (or carrier index), SL Tx or Rx resource allocation information, and so on.

Patent Literature 1 describes that after PC5 carrier aggregation is configured, the UE may notify this to the base station (see, for example, FIG. 6 in Patent Literature 1). The notification message may include at least one of a set of carrier frequency information, a deactivation timer, and a peer UE identifier. For each SL component carrier, the notification message may further include a reception (Rx) or transmission (Tx) indicator, a primary or secondary SL indicator, a type of carrier aggregation (e.g., data replication or data split), a V2X service type, a synchronization type, a primary SL index (or carrier index), a secondary SL index (or carrier index), SL Tx or Rx resource allocation information, and so on.

Patent Literature 1 states that a UE may send a request for SL carrier aggregation configuration between the UE and a peer UE to the base station, and the base station may generate the configuration and provide it to the UE (see, for example, FIG. 9 in Patent Literature 1). Patent Literature 1 also states that the request message is optional and that the base station may provide the SL carrier aggregation configuration to the UE regardless of receipt of the request message from the UE.

Patent Literature 1 describes that UEs may exchange information about their respective SL carrier aggregation capability directly with each other prior to configuring SL carrier aggregation (see, for example, FIG. 13 in Patent Literature 1). The SL carrier aggregation capability includes one or both of the following: SL band combination information, SL and Uu band combination information. Uu is the air interface between the UE and the base station. The band combination information sent by the UE indicates the list of carriers and the bandwidth of each carrier on which the UE can operate simultaneously. The UE may indicate whether it supports both transmit (Tx) and receive (Rx) or only one of transmit (Tx) and receive (Rx) on each carrier.

Patent Literature 2 describes that a UE receives from a wireless wide area network (WAN) a Radio Resource Control (RRC) signal (e.g., RRC Connection Reconfiguration message) containing a command to add or release a component carrier of a V2X carrier aggregation (see, for example, FIGS. 2 and 3 of Patent Literature 2).

Patent Literature 3 describes that a first wireless device receives a sidelink message containing sidelink capability information of a second wireless device from the second wireless device via a sidelink channel and transmits an uplink message containing the sidelink capability information to the base station (see, e.g., FIG. 25 in Patent Literature 3). The sidelink capability information of the second wireless device may indicate whether the second wireless device supports sidelink multiple carrier operation (e.g., sidelink carrier aggregation, sidelink multiple carriers, sidelink multi-carrier), a supported/operating sidelink (e.g., LTE, 5G, etc.), an available band, whether the second wireless device supports an unlicensed band (or unlicensed spectrum), and the like. The base station may determine configuration parameters for sidelink communication between the first and second wireless devices based on the sidelink capability information of the second wireless device, and send those configuration parameters to the first wireless device. The configuration parameters may be sent in an RRC message, a Medium Access Control (MAC) Control Element (CE), or a Physical Downlink Control Channel (PDCCH) transmission (e.g., Downlink Control Information (DCI)).

Patent Literature 3 describes that the first wireless device receives a sidelink message containing band combination information of the second wireless device from the second wireless device via a sidelink channel, and transmits an uplink message (e.g., an RRC message) containing the band combination information to the base station (see, for example, FIG. 26 of Patent Literature 3). The band combination information of the second wireless device may indicate one or more bands that are allowed to be used simultaneously for sidelink communication at the second wireless device. The band combination information of the second wireless device may indicate whether the second wireless device supports multiple sidelink carriers (e.g., multicarrier operation, sidelink carrier aggregation). For example, the base station may determine or assign resources corresponding to multiple carriers if the band combination information indicates that the second wireless device supports multiple sidelink carriers. The base station transmits configuration parameters for sidelink communication between the first and second wireless devices to the first wireless device. The configuration parameters may indicate a sidelink resource assignment. More specifically, the sidelink resource assignment may indicate a first sidelink radio resource in the first carrier and a second sidelink radio resource in the second carrier. The first wireless device may transmit a first transport block to the second wireless device on the first sidelink radio resource and a second transport block to the second wireless device on the second sidelink radio resource.

### CITATION LIST

### Patent Literature

[Patent Literature 1] WO 2019/023857 A1
[Patent Literature 2] US 2019/0246377 A1
[Patent Literature 3] US 2021/0051653 A1

### Non Patent Literature

[Non-Patent Literature 1] 3GPP TR 37.985 V17.0.0 (2021 December) “3rd Generation Partnership Project; Technical Specification Group Radio Access Network; Overall description of Radio Access Network (RAN) aspects for Vehicle-to-everything (V2X) based on LTE and NR (Release 17)”, December 2021
[Non-Patent Literature 2] 3GPP TS 23.287 V17.2.0 (2021 December) “3rd Generation Partnership Project; Technical Specification Group Services and System Aspects; Architecture enhancements for 5G System (5GS) to support Vehicle-to-Everything (V2X) services (Release 17)”, December 2021
[Non-Patent Literature 3] 3GPP TS 24.587 V17.4.1 (2021 December) “3rd Generation Partnership Project; Technical Specification Group Core Network and Terminals; Vehicle-to-Everything (V2X) services in 5G System (5GS); Stage 3 (Release 17)”, December 2021
[Non-Patent Literature 4] Huawei, HiSilicon, “WI summary for V2X phase 2 based on LTE”, RP-180858, 3GPP TSG RAN Meeting #80, San Diego, USA, Jun. 11-14, 2018
[Non-Patent Literature 5] OPPO, LG Electronics, “New WID on NR sidelink evolution”, RP-213678, 3GPP TSG RAN Meeting #94e, Electronic Meeting, Dec. 6-17, 2021

### SUMMARY OF INVENTION

### Technical Problem

The inventor has studied carrier aggregation for D2D communication, including NR sidelink communication, and found various problems. Carrier aggregation on a D2D interface or sidelink interface (e.g., PC5 interface) between radio terminals can also be referred to as multicarrier operation. One of these problems relates to how UEs use multiple sidelink carriers. For example, it may be desirable that a particular type of message or data, and more specifically a message or data from a particular type of radio bearer, be transmitted on a particular sidelink carrier. The Non-Patent Literature and the Patent Literature discussed above do not provide a solution to allow this.

One of the objects that the example embodiments disclosed herein seek to achieve is to provide apparatuses, methods, and programs that contribute to solving at least one of a plurality of problems, including the above-described problems related to carrier aggregation on a D2D interface between radio terminals. It should be noted that this object is only one of the objects to be achieved by the example embodiments disclosed herein. Other objects or problems and novel features will become apparent from the following description and the accompanying drawings.

### Solution to Problem

In a first aspect, a radio terminal includes at least one radio transceiver and at least one processor coupled to the at least one radio transceiver. The at least one processor is configured to perform sidelink communication with a peer radio terminal on a primary carrier and a secondary carrier. The at least one processor is configured to use the primary carrier without using the secondary carrier to transmit control plane data belonging to a first type of sidelink signaling radio bearer and control plane data belonging to a second type of sidelink signaling radio bearer. The first type of sidelink signaling radio bearer is used to transmit an unsecured upper layer message. The second type of sidelink signaling radio bearer is used to transmit an upper layer message for establishing security for a unicast link for the sidelink communication.

In a second aspect, a method performed by a radio terminal includes: (a) performing sidelink communication with a peer radio terminal on a primary carrier and a secondary carrier; and (b) using the primary carrier without using the secondary carrier to transmit control plane data belonging to a first type of sidelink signaling radio bearer and control plane data belonging to a second type of sidelink signaling radio bearer. The first type of sidelink signaling radio bearer is used to transmit an unsecured upper layer message. The second type of sidelink signaling radio bearer is used to transmit an upper layer message for establishing security for a unicast link for the sidelink communication.

In a third aspect, a program includes a set of instructions (software codes) that, when loaded into a computer, cause the computer to perform the method according to the second aspect described above.

### Advantageous Effects of Invention

According to the aspects described above, it is possible to provide apparatuses, methods and programs that contribute to solving at least one of a plurality of problems related to carrier aggregation on a D2D interface between radio terminals.

### BRIEF DESCRIPTION OF DRAWINGS

FIG. 1 shows an example configuration of a radio communication system according to an example embodiment;

FIG. 2 shows an example configuration of a radio communication system according to an example embodiment;

FIG. 3 shows an AS protocol stack of a control plane for RRC on the PC5 interface;

FIG. 4 shows an AS protocol stack of a control plane for PC5-S on the PC5 interface;

FIG. 5 shows an AS protocol stack of a user plane on the PC5 interface;

FIG. 6 shows an example of the structure of NR sidelink layers 2 and 1 with carrier aggregation configured;

FIG. 7 is a flowchart showing an example of an operation of a UE according to an example embodiment;

FIG. 8 is a flowchart showing an example of an operation of a UE according to an example embodiment;

FIG. 9 is a flowchart showing an example of an operation of a UE according to an example embodiment;

FIG. 10 is a flowchart showing an example of an operation of a UE according to an example embodiment;

FIG. 11 shows an example of signaling between UEs according to an example embodiment;

FIG. 12 shows an example of signaling between UEs according to an example embodiment;

FIG. 13 shows an example of signaling between UEs according to an example embodiment;

FIG. 14 is a block diagram showing an example configuration of a UE according to an example embodiment;

FIG. 15 is a block diagram showing an example configuration of a radio access network node according to an example embodiment; and

FIG. 16 is a block diagram showing an example configuration of a core network node and an application server according to an example embodiment.

### EXAMPLE EMBODIMENT

Specific example embodiments will be described hereinafter in detail with reference to the drawings. The same or corresponding elements are denoted by the same symbols throughout the drawings, and duplicated explanations are omitted as necessary for the sake of clarity.

Each of the example embodiments described below may be used individually, or two or more of the example embodiments may be appropriately combined with one another. These example embodiments include novel features different from each other. Accordingly, these example embodiments contribute to attaining objects or solving problems different from one another and contribute to obtaining advantages different from one another.

The example embodiments presented below are primarily described for the 3GPP 5th generation mobile communication system (5G system). However, these example embodiments can be applied to other radio communication systems that support D2D communication technology similar to 3GPP NR sidelink communication.

As used in this specification, “if” can be interpreted to mean “when”, “at or around the time”, “after”, “upon”, “in response to determining”, “in accordance with a determination”, or “in response to detecting”, depending on the context. These expressions can be interpreted to mean the same thing, depending on the context.

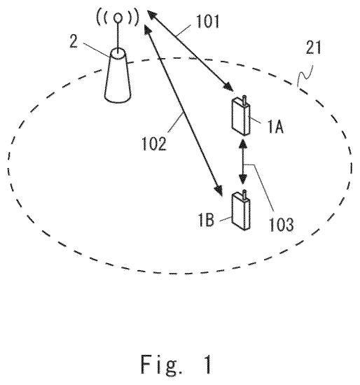

First, the configuration and operation of a plurality of network elements common to a plurality of example embodiments are described. FIG. 1 shows an example configuration of a radio communication system according to a plurality of example embodiments. Each element (or network function) shown in FIG. 1 can be implemented, for example, as a network element on dedicated hardware, as a software instance running on dedicated hardware, or as a virtualized function instantiated on an application platform.

A radio access network (RAN) node (e.g., gNB) 2 manages a cell 21 and is capable of performing cellular communications (101 and 102) with a plurality of radio terminals (UEs) 1, including UEs 1A and 1B, using a cellular communication technology (i.e., NR radio access network). The cellular communication 101 uses an air interface (e.g., Uu interface) between the RAN node 2 and the UE 1A. Similarly, the cellular communication 102 uses an air interface (e.g., Uu interface) between the RAN node 2 and the UE 1B. The example in FIG. 1 shows a situation where the UEs 1A and 1B are located in the same cell 21 for ease of explanation, but such an arrangement is only an example. For example, the UE 1A may be located in one of two adjacent cells managed by different RAN nodes 2, and the UE 1B may be located in the other cell. Alternatively, at least one of the UE 1A and the UE 1B may be located outside the coverage of one or more RAN nodes 2 (i.e., partial coverage, out-of-coverage).

Each of the UEs 1A and 1B has at least one radio transceiver and is configured to perform cellular communication (101 or 102) with the RAN node 2 and to perform D2D communication (i.e., sidelink communication) on a direct inter-UE interface (i.e., NR PC5 interface or NR sidelink) 103. The sidelink communication includes unicast mode communication (sidelink unicast) and may further include one or both of groupcast mode communication and broadcast mode communication.

The interface between 3GPP radio terminals (i.e., UEs) used in the control and user planes for D2D communication is called the PC5 interface (or reference point). D2D communication over the PC5 interface is referred to as sidelink communication. The PC5 interface can be based on the E-UTRA sidelink capability and can also be based on the 5G NR sidelink capability. D2D (or sidelink) communication over the E-UTRA-PC5 (or LTE-based PC5) interface is connectionless, i.e., broadcast mode at the AS layer. In contrast, sidelink communication over the NR PC5 interface supports unicast mode, groupcast mode, and broadcast mode at the AS layer.

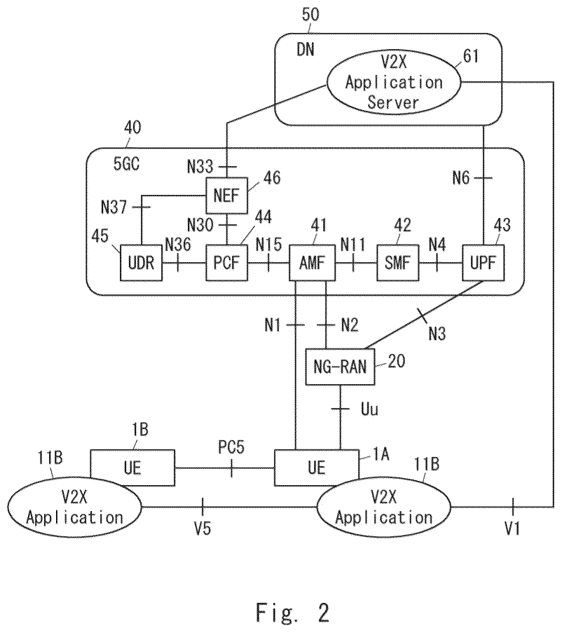

In some implementations, the sidelink communication between the UEs 1A and 1B may be used for cellular V2X services and V2X communication. In other words, the UEs 1A and 1B and the RAN node 2 shown in FIG. 1 may be used in a 5G system providing V2X communications over PC5. FIG. 2 shows an example of a non-roaming 5G system architecture for V2X communication over PC5. Each element (or network function) shown in FIG. 2 can be implemented, for example, as a network element on dedicated hardware, as a software instance running on dedicated hardware, or as a virtualized function instantiated on an application platform. The major reference points (or interfaces) shown in FIG. 2 are described below.

In the following description, when describing matters common to multiple UEs, including the UEs 1A and 1B, it will be referred to simply as UE 1 with the reference sign 1.

The V1 reference point is a reference point between a V2X application (e.g., V2X application 11A or V2X application 11B) in a UE 1 (e.g., UE 1A or UE 1B) and a V2X application in a V2X application server 61. The V2X application server 61 is located in a data network (DN) 50.

The V5 reference point is a reference point between V2X applications of two UEs 1 (e.g., UE 1A and UE 1B). The PC5 reference point is a reference point between UEs (e.g., UE 1A and UE 1B) and includes the NR based PC5. The Uu reference point is a reference point between a UE (e.g., UE 1A) and an NG-RAN 20. Although not shown in FIG. 2, the UE 1B can also communicate with the NG-RAN 20 via the Uu reference point, as already described.

The N1 reference point is a reference point between a UE 1 (e.g., UE 1A) and an Access and Mobility management Function (AMF) 41 in a 5G Core Network (5GC) 40. The N1 reference point can be used to send V2X policies and parameters from the AMF 41 to the UE 1, and to send the V2X capability and PC5 capability of the UE 1 for V2X communication from the UE 1 to the AMF 41. The N2 reference point is a reference point between the NG-RAN 20 and the AMF 41. The N2 reference point may be used to send V2X policies and parameters from the AMF 41 to the NG-RAN 20. The AMF 41 is one of the network function nodes in the control plane of the 5GC 40. The AMF 41 terminates a single signalling connection (i.e., N1 NAS signalling connection) with the UE 1 (e.g., UE 1A) and provides registration, connection management, and mobility management. The AMF 41 provides network function (NF) services on a service-based interface (i.e., Namf interface) to NF consumers (e.g., Session Management Function (SMF) 42). The NF services provided by the AMF 41 include a communication service (Namf_Communication). The communication service allows an NF consumer (e.g., SMF 42) to communicate with the UE 1 or the NG-RAN 20 through the AMF 41.

The N3 reference point is a reference point between the NG-RAN 20 and a User Plane Function (UPF) 43 in the 5GC. The N6 reference point is a reference point between the UPF 43 and the DN 50. The UPF 43 is one of the network function nodes in the user plane of the 5GC 40. The UPF 43 processes and forwards user data. The functionality of the UPF 43 is controlled by the SMF 42 through the N4 reference point. The UPF 43 may include multiple UPFs connected through N9 reference points. For example, to enable the V2X application 11B in the UE 1A to communicate with the V2X application in the V2X application server 61, the UE 1A uses a path, association, session, or connection through the Uu, N3, and N6 reference points.

The 5G system shown in FIG. 2 may provide Network Exposure Function (NEF) services to enable communication between one or more network functions within the 5GC 40 and the V2X application server 61. A NEF 46 is one of the network function nodes in the control plane of the 5GC 40. The NEF 46 supports the exposure of services and capabilities from the 5G system to application functions and network functions within and outside the operator network. The N33 reference point is a reference point between the NEF 46 and an application function (e.g., V2X application server 61). The NEF 46 provides NF services to NF consumers (e.g., V2X application server 61) on a service-based interface (i.e., Nnef interface). In the case of V2X services, the services provided by the NEF 46 may be used by the V2X application server 61 to update V2X service-related information in the 5GC 40. The NEF 46 may store V2X service-related information in a Unified Data Repository (UDR) 45 either directly through the N37 reference point or through a Policy Control Function (PCF) 44.

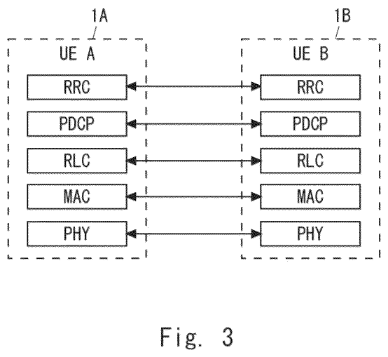

FIGS. 3, 4, and 5 show the AS protocol stacks of the PC5 interface 103. As shown in FIG. 3, the Access Stratum (AS) protocol stack of the control plane for the Sidelink Control Channel (SCCH) for Radio Resource Control (RRC) includes the RRC, Packet Data Convergence Protocol (PDCP), Radio Link Control (RLC), and Medium Access Control (MAC) sublayers and the Physical (PHY) layer. The SCCH is a sidelink logical channel for the transmission of control information (i.e., PC5-RRC and PC5-S messages) from one UE (e.g., UE 1A) to another UE(s) 1 (e.g., UE 1B).

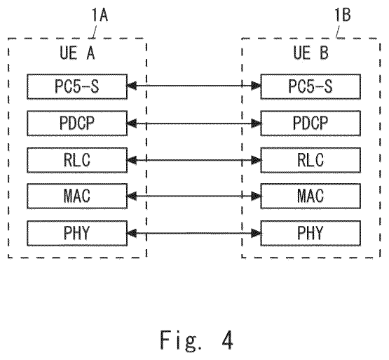

The PC5 interface 103 supports the PC5 Signaling (PC5-S) protocol. As shown in FIG. 4, PC5-S sits on top of the PDCP, RLC, and MAC sublayers and the physical layer in the AS protocol stack of the control plane for SCCH for PC5-S. PC5-S is used for control plane signaling over the PC5 interface 103 for a secure unicast Layer-2 link (or PC5 unicast link). Specifically, PC5-S provides signaling to establish, modify, and release the PC5 unicast link. The PC5 unicast link between the UE 1A and the UE 1B is associated with the Application Layer ID and Layer-2 ID of the UE 1A and the Application Layer ID and Layer-2 ID of the UE 1B. The PC5 unicast link is bidirectional. Therefore, the UE 1A can send application data (e.g., V2X service data, public safety service data) to the UE 1B over the PC5 unicast link with the UE 1B, while the UE 1B can also send application data to the UE 1A over the same PC5 unicast link.

There is a one-to-one correspondence between the PC5 unicast link and the PC5-RRC connection. The PC5-RRC connection is a logical connection between two UEs 1 for a pair of a Source Layer-2 ID and a Destination Layer-2 ID. The PC5-RRC connection is considered to be established after the corresponding PC5 unicast link is established. In other words, the PC5-RRC connection is established in response to the establishment of its corresponding PC5 unicast link. Specifically, when the transmission of a PC5-S message to a specific destination is requested by the upper layers of a sidelink signalling radio bearer (SL SRB), the UE 1 (RRC layer) establishes a PDCP entity, an RLC entity, and an SCCH of the SL SRB for the PC5-S message, based on a predefined SCCH configuration, and then considers a PC5-RRC connection to be established for the destination. Alternatively, when the establishment of a PC5-RRC connection for a specific destination is indicated by the upper layers, the UE 1 (RRC layer) establishes a PDCP entity, an RLC entity, and an SCCH of the SL SRB for PC5-RRC messages for this destination, based on a predefined SCCH configuration, and then considers this PC5-RRC connection to be established.

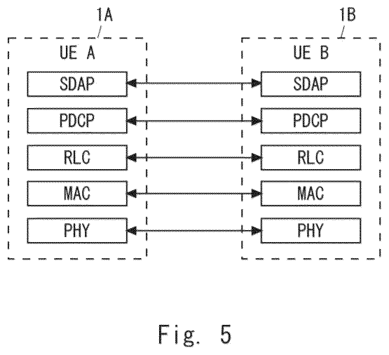

FIG. 5 shows the AS user plane protocol stack for the Sidelink Traffic Channel (STCH). The STCH is a sidelink logical channel for the transmission of user data (e.g., V2X service data, public safety service data) from one UE 1 (e.g., UE 1A) to another UE(s) 1 (e.g., UE 1B). This protocol stack includes the Service Data Adaptation Protocol (SDAP), PDCP, RLC, and MAC sublayers, and the physical layer.

NR sidelink communication on the NR PC5 interface 103 supports two resource allocation modes, i.e., mode 1 and mode 2.

In resource allocation mode 1, the RAN node 2 (e.g., gNB) performs resource allocation. For example, the RAN node 2 allocates or schedules SL radio resources to the UE 1 using the NR Uu interface 101. Resource allocation by mode 1 includes a dynamic grant and a configured grant.

In the case of a dynamic grant, the UE 1 should request resources from the RAN node 2 for the transmission of every single transport block. Specifically, the UE 1 sends a MAC Control Element (CE) (i.e., Sidelink BSR MAC CE) indicating a Sidelink Buffer Status Report (BSR) to the RAN node 2 via an Uplink Shared Channel (UL-SCH) and a Physical Uplink Shared Channel (PUSCH), and the RAN node 2 sends Downlink Control Information (DCI) indicating a dynamic sidelink grant to the UE 1 via a Physical Downlink Control Channel (PDCCH). A dynamic sidelink grant provides allocation of resources for the transmission (and retransmission) of a single transport block. When sidelink carrier aggregation, described below, is configured, a dynamic sidelink grant may provide an allocation of resources for one transport block per sidelink (component) carrier.

In the case of a configured grant, the RAN node 2 allows periodic sidelink resources to the UE 1, which are semi-statically configured by the RRC. Specifically, the UE 1 can send UE assistance information about a sidelink communication traffic pattern to the RAN node 2. Such UE assistance information, or sidelink traffic pattern information sent in UE assistance information, may be referred to as configured grant assistance information. The sidelink traffic pattern information (or configured grant assistance information) may include, for example, the maximum transport block size based on an observed traffic pattern; an estimated timing of packet arrival on a sidelink logical channel; and an estimated data arrival cycle on a sidelink logical channel. The UE 1 sends UE assistance information, including sidelink traffic pattern information, using an RRC message (e.g., UEassistanceinformation message). The RAN node 2 may consider the sidelink traffic pattern information received from the UE 1 and generate a configured grant. The RAN node 2 transmits a configured grant to the UE 1 using an RRC message (e.g., RRCReconfiguration message). A configured grant indicates an allocation of time and frequency resources and the cycle of that resource allocation. There are two types of configured grant for mode 1. In configured grant type 1, a configured grant can be configured or released to the UE 1 by RRC signaling and can be used immediately. In the case of configured grant type 2, the RAN node 2 configures a configured grant to the UE 1 via RRC signaling and activates or deactivates this configured grant via DCI signaling. The UE 1 can only use the periodic resources allocated by the configured grant after it has been activated by the RAN node 2 and only until it is deactivated.

On the other hand, in resource allocation mode 2, the UE 1 autonomously selects resources based on sensing by the UE 1. The sensing is performed in a preconfigured resource pool. If resources are not being used by other UEs for high priority traffic, the UE 1 can select these resources for sidelink transmission and retransmission. The UE 1 is allowed to transmit and retransmit on the selected resources a certain number of times until a resource reselection reason is triggered.

The UEs 1A and 1B support carrier aggregation (CA) on the NR PC5 interface (or NR sidelink) 103. In other words, the UEs 1A and 1B support NR sidelink carrier aggregation, i.e., carrier aggregation for NR sidelink communication. Sidelink carrier aggregation can also be referred to as multicarrier operation. Sidelink carrier aggregation allows the UEs 1A and 1B to communicate with each other on multiple sidelink carriers. Similar to the terminology used for the Uu interface, multiple sidelink carriers used in sidelink carrier aggregation can be referred to as component carriers. In one example, one or more of the multiple sidelink carriers may belong to a licensed spectrum (or licensed band) licensed to the RAN node 2 (or NG-RAN 20) or its operator, while the other one or more may belong to an unlicensed spectrum. The unlicensed spectrum may be ITS spectrum for intelligent transportation systems (ITS).

The UE 1A and the UE 1B support sidelink carrier aggregation in unicast transmissions. The UE 1A and the UE 1B may support sidelink carrier aggregation in groupcast transmissions. The UE 1A and the UE 1B may support sidelink carrier aggregation in broadcast transmissions.

In sidelink carrier aggregation, one or both of the UEs 1A and 1B may not necessarily be able to transmit on multiple sidelink carriers simultaneously. In other words, one or both of the UEs 1A and 1B may not support transmission on multiple sidelink carriers in the same time slot. A UE with such limited transmission capability may be referred to as a limited Tx capability UE. For example, the limited Tx capability may be due to the fact that the number of transmission chains in the UE 1 is less than the number of configured transmit sidelink carriers. Alternatively, the limited Tx capability may be due to the UE 1 not supporting a band combination of configured transmit sidelink carriers. Alternatively, the limited Tx capability may be due to the time required to switch between transmission chains in the UE 1. Alternatively, the limited Tx capability may be due to the inability of the UE 1 to meet radio frequency (RF) requirements such as power spectral density (PSD) imbalance.

Similarly, in sidelink carrier aggregation, one or both of the UEs 1A and 1B may not necessarily be able to receive on multiple sidelink carriers simultaneously. In other words, one or both of the UEs 1A and 1B may not support receiving on multiple sidelink carriers in the same time slot. A UE with such limited receive capabilities may be referred to as a limited Rx capability UE.

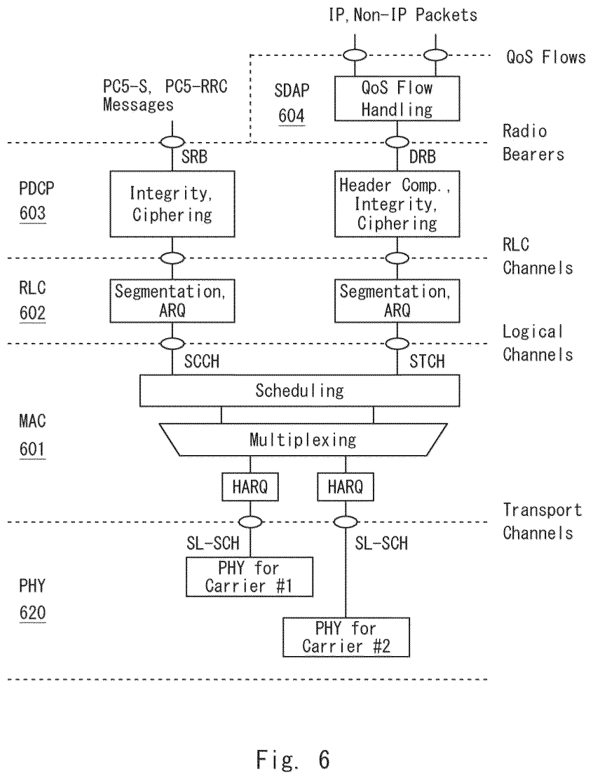

FIG. 6 shows an example of the structure of NR Sidelink Layers 2 and 1 with carrier aggregation configured. Sidelink Layer 2 includes a MAC sublayer 601, an RLC sublayer 602, a PDCP sublayer 603, and an SDAP sublayer 604. In principle, sidelink carrier aggregation is a concept for the MAC sublayer 601 and the physical layer 620 and does not apply to the RLC sublayer 602 and higher layers. However, as discussed below, PC5-RRC messages related to sidelink carrier aggregation may be introduced.

The Physical Layer 620 supports multiple sidelink carriers. If the UE supports transmission on multiple sidelink carriers in the same time slot, the physical layer 620 can transmit a transport block (or MAC Protocol Data Unit (PDU)) on each sidelink carrier in the same time slot. The physical layer 620 offers transport channels to the MAC sublayer 601.

The MAC sublayer 601 provides a single MAC entity for transmission and reception on multiple sidelink carriers. The MAC entity provides a hybrid automatic repeat request (HARQ) entity per sidelink carrier. A single HARQ entity maintains multiple HARQ processes, allowing transmissions to continue on the corresponding sidelink carrier while waiting for HARQ feedback on the success or failure of previous transmissions.

The MAC sublayer 601 offers logical channels to the RLC sublayer 602. The MAC sublayer 601 provides a mapping between logical channels and transport channels, and multiplexes MAC Service Data Units (SDUs) belonging to the same or to different logical channels. Transport channels used in the NR sidelink include a Sidelink Shared Channel (SL-SCH) and a Sidelink Broadcast Channel (SL-BCH). Logical channels used in the NR sidelink include a Sidelink Control Channel (SCCH), a Sidelink Traffic Channel (STCH), and a Sidelink Broadcast Control Channel (SBCCH). SCCH is a control channel and is mapped to SL-SCH. STCH is a traffic channel and is mapped to SL-SCH in a similar way to SCCH. SBCCH is a control channel and is mapped to SL-BCH.

The MAC sublayer 601 provides scheduling for the NR sidelink. This scheduling includes priority handling among multiple logical channels through logical channel prioritization.

If the UE supports transmission on multiple sidelink carriers in the same time slot and has a grant on each of the multiple sidelink carriers, the MAC sublayer provides multiple transport blocks (MAC PDUs) to the physical layer 620 through multiple transport channels (i.e., SL-SCHs), each associated with a respective one of the multiple sidelink carriers, in order to transmit on the multiple sidelink carriers in the same time slot. Each grant may be a dynamic grant or a configured grant in resource allocation mode 1. Alternatively, if the MAC entity is configured with sidelink resource allocation mode 2 to transmit using a resource pool, the MAC entity may generate a sidelink grant selected based on random selection or sensing in the resource pool.

The RLC sublayer 602 offers RLC channels to the PDCP sublayer 603. The RLC sublayer 602 supports three transmission modes, Acknowledged Mode (AM), Unacknowledged Mode (UM), and Transparent Mode (TM). In AM and UM, the RLC sublayer 602 provides segmentation of RLC SDUs. In AM, the RLC sublayer 602 provides ARQ (i.e., retransmission of RLC SDUs or RLC SDU segments).

The PDCP sublayer 603 offers Data Radio Bearers (DRBs) to the SDAP sublayer 604. The PDCP sublayer 603 receives user plane data of DRBs from the SDAP sublayer 604 and provides header compression, integrity protection, and ciphering, for example.

In addition, the PDCP sublayer 603 offers Signalling Radio Bearers (SRBs) to upper layers (i.e., PC5-S layer, PC5-RRC layer). The PDCP sublayer 603 receives control plane data (i.e., PC5-S and PC5-RRC messages) of SRBs from the PC5-S layer and the PC5-RRC layer and provides integrity protection and ciphering, for example.

The SDAP sublayer 604 provides Quality of Service (QOS) flow handling. A QoS flow may be an Internet Protocol (IP) flow, i.e., IP packets. Alternatively, a QoS flow may be a non-IP flow, i.e., non-IP packets. The SDAP sublayer 604 provides a mapping between Qos flows and SL DRBs. There is one SDAP entity per destination for one of unicast, groupcast, and broadcast associated with that destination.

A receiving UE (e.g., UE 1B) performs a Physical Sidelink Feedback Channel (PSFCH) transmission in response to a PSSCH received a few slots earlier. How many slots later a UE that has received a PSSCH transmission in a given slot can transmit HARQ feedback for that PSSCH transmission in a PSFCH symbol depends on the period of the PSFCH symbols, and also on the minimum time gap between the slot with the PSSCH transmission and the slot containing the HARQ feedback. Within a resource block, resources for PSFCH are configured periodically, for example, in cycles of 1, 2, or 4 slots. In other words, within a resource pool, there is a slot with a PSFCH every 1, 2, or 4 slots. In addition, for each resource pool, a minimum number of slots (i.e., minimum time gap) is configured between the slot with the PSSCH transmission and the slot containing the PSFCH for HARQ feedback for that PSSCH transmission. For example, the minimum time gap is 2 or 3.

Specifically, a sidelink resource pool configuration may include PSFCH-related configurations (e.g., SL-PSFCH-Config), including a configuration of the PRBs to be used for PSFCH transmission and reception (e.g., sl-PSFCH-RB-Set), a configuration of the PSFCH period (e.g., sl-PSFCH-Period), and a configuration of the minimum time gap (e.g., sl-MinTimeGapPSFCH). The sidelink resource pool configuration (e.g., SL-BWP-PoolConfigCommon) can be included in a sidelink common configuration (e.g., SL-ConfigCommon) that is broadcast in the system information (e.g., System Information Block 12 (SIB12)). Alternatively, the sidelink resource pool configuration (e.g., SL-BWP-PoolConfig) can be included in a sidelink configuration (e.g., SL-BWP-PoolConfig in sl-ConfigDedicatedNR) that is sent in a UE-specific RRC message (e.g., RRCReconfiguration message). Alternatively, the sidelink resource pool configuration (e.g., SL-BWP-PoolConfigCommon) can be included in a sidelink configuration (e.g., SL-BWP-PoolConfig in SL-PreconfigurationNR) that is preconfigured in the UE.

The receiving UE transmits a PSFCH in the first slot that contains a PSFCH resource and is at least the number of slots later than the last slot of the PSFCH reception as specified in the minimum time gap configuration (e.g., sl-MinTimeGapPSFCH) of the resource pool. Accordingly, if the PSFCH period is four slots, HARQ feedback for PSSCH transmissions in four PSSCH slots can be transmitted in multiple PRBs within a single PSFCH symbol in a single slot.

### First Example Embodiment

This example embodiment provides improvements related to carrier aggregation in the NR sidelink. Specifically, this example embodiment relates to clarifying a mapping between sidelink radio bearers and aggregated sidelink carriers. The configuration and operation of a radio communication system and network elements (or apparatuses, nodes, devices, or network functions) in this example embodiment may be the same as in the examples described with reference to FIGS. 1 to 6.

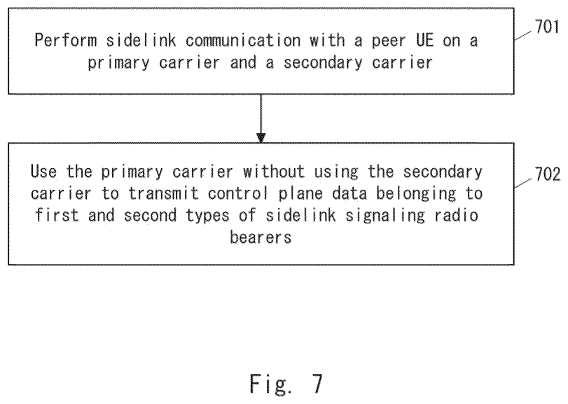

FIG. 7 shows an example of the operation of the UE 1 (e.g., UE 1A). In step 701, the UE 1A performs sidelink communication with the peer UE 1B on a primary carrier and one or more secondary carriers. In other words, the UE 1A uses a primary carrier and one or more secondary carriers to perform sidelink communication with the peer UE 1B. The sidelink communication may be unicast.

In step 702, the UE 1A uses the primary carrier without using the secondary carrier to transmit control plane data belonging to a first type of sidelink signaling radio bearer (SL SRB) and control plane data belonging to a second type of sidelink signaling radio bearer (SL SRB). The first type of SL SRB is used to transmit an unsecured upper layer message (e.g., PC5-S message). The second type of SL SRB is used to transmit an upper layer message (e.g., PC5-S message) for establishing security for a unicast link (e.g., PC5 unicast link) for the sidelink communication. This security can be PC5-S security or Access Stratum (AS) security. This security allows the PDCP sublayer 603 to protect signaling (or SL SRBs messages) and user plane data (or SL DRBs data) transmitted and received between the UE 1A and the UE 1B.

That is, the first type of SL SRB may be a Sidelink Signalling Radio Bearer 0 (SL-SRB0) and the second type of SL SRB may be a Sidelink Signalling Radio Bearer 1 (SL-SRB1). For a unicast PC5-RRC connection, SL-SRB0 is used to transmit one or more PC5-S messages before PC5-S security is established. Meanwhile, SL-SRB1 is used to transmit multiple PC5-S messages to establish PC5-S security.

In particular, the UE 1A may distinguish the first and second types of SL SRBs or their associated first and second logical channels (i.e., SCCHs) from other SL SRBs and SL DRBs or their associated logical channels (i.e., SL SRBs and SL DRBs). The UE 1A may then include data (i.e., MAC SDUs) from the first and second logical channels in a transport channel, one or more transport blocks, or one or more MAC PDUs to be transmitted on the primary carrier. These operations may be performed by the MAC sublayer 601 of the UE 1A or by a MAC entity in the MAC sublayer 601.

The primary carrier may be referred to as the primary component carrier, primary link, primary sidelink, or primary unicast link. Similarly, the secondary carrier may be referred to as the secondary component carrier, secondary link, secondary sidelink, or secondary unicast link.

In some implementations, the primary carrier may be a carrier on which a bidirectional PC5 unicast link or PC5-RRC connection is first established. The secondary carrier, on the other hand, may be a carrier that begins to be used for transmission on a PC5 unicast link associated with the PC5-RRC connection after the PC5-RRC connection is established on the primary carrier. The secondary carrier may be added, modified, or released by exchanging PC5-RRC signaling on the PC5-RRC connection between the UE 1A and the peer UE 1B via the primary carrier.

The operation of the UE 1 described with reference to FIG. 7 allows the UE 1 to transmit control plane data (or messages) for specific SL SRBs on a specific sidelink carrier.

In addition, the UE 1 may use the primary carrier without using the secondary carrier to transmit control plane data belonging to a third type of SL SRB. The third type of SL SRB is used to transmit upper layer messages (e.g., PC5-S messages) after the security (e.g., PC5-S security or AS security) has been established. Specifically, the third type of SL SRB may be a Sidelink Signalling Radio Bearer 2 (SL-SRB2).

In addition, the UE 1 may use the primary carrier without using the secondary carrier to transmit control plane data belonging to a fourth type of SL SRB. The fourth type of SL SRB is used to transmit PC5-RRC messages after the PC5-S security or AS security has been established. Specifically, the fourth type of SL SRB may be a Sidelink Signalling Radio Bearer 3 (SL-SRB3).

The UE 1 may operate to use one or more secondary carriers to transmit user data belonging to one or more SL DRBs, but not to use these secondary carriers to transmit control plane data belonging to any of the SL SRBs.

For example, when the primary carrier belongs to a licensed spectrum and the secondary carrier belongs to an unlicensed spectrum, the above-described behavior of the MAC sublayer 601 (or MAC entity) of the UE 1 of transmitting one or more specific sidelink radio bearers, in particular one or more specific SL SRBs, on the primary carrier is effective. The unlicensed spectrum may be ITS spectrum. The licensed spectrum is likely to provide a relatively more stable or higher quality radio communications than the unlicensed spectrum because there is no conflict with other radio systems in the licensed spectrum. Thus, the transmission on the primary carrier belonging to the licensed spectrum of control messages for SL SRBs (e.g., SL SRB0, SL SRB1, etc.) necessary to establish and maintain a PC5 unicast link and PC5-RRC connection may contribute to the provision of a stable PC5 unicast link and PC5-RRC connection.

### Second Example Embodiment

This example embodiment provides improvements related to carrier aggregation in the NR sidelink. Specifically, this example embodiment relates to a method of configuring, determining, or selecting sidelink primary and secondary carriers. The configuration and operation of a radio communication system and network elements (or apparatuses, nodes, devices, or network functions) in this example embodiment may be the same as in the examples described with reference to FIGS. 1 to 6.

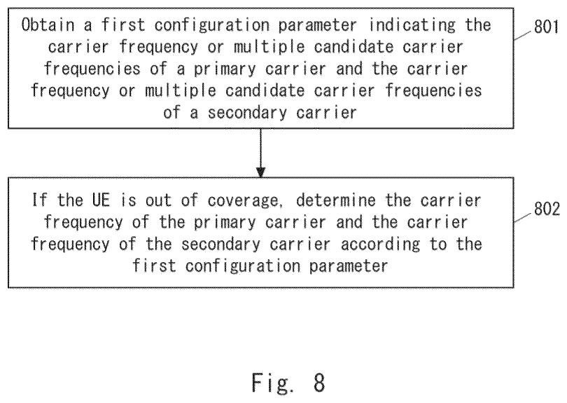

FIG. 8 shows an example of the operation of the UE 1 when the UE 1 is outside the coverage of the RAN node 2 (or the NG-RAN 20). The UE 1 has a memory configured to store a first configuration parameter(s) indicating the carrier frequency or multiple candidate carrier frequencies of the primary carrier and the carrier frequency or multiple candidate carrier frequencies of the secondary carrier. The memory may be a non-volatile memory in the Mobile Equipment (ME) or may be a Universal Subscriber Identity Module (USIM). The first configuration parameter may be referred to as configuration information, preconfigured parameter, or preconfigured information. The first configuration parameter may be provided by a core network node (e.g., AMF 41, PCF 44) to the UE 1 via the N1 reference point between the AMF 41 and the UE 1. Alternatively, the first configuration parameter may be provided by the V2X application server 61 to the UE 1 via the V1 reference point between the UE 1 and the V2X application server 61. In step 801, the UE 1 obtains the first configuration parameter. This may mean that the UE 1 reads the first configuration parameter from the memory. Alternatively, it may mean that the UE 1 receives the first configuration parameter from a core network node or the V2X application server 61 and stores it in the memory.

In step 802, when the UE 1 is out of coverage of the RAN node 2 (or the NG-RAN 20), the UE 1 determines the carrier frequency of the primary carrier and the carrier frequency of the secondary carrier according to the first configuration parameter(s) stored in the memory. The UE 1 may determine the carrier frequencies of two or more secondary carriers. The UE 1 may determine whether the UE 1 is in or out of coverage in the same way as an existing method. The fact that the UE 1 is within the coverage of the RAN node 2 or the NG-RAN 20 may mean that the UE 1 has selected one of the cells provided by the RAN node 2 or the NG-RAN 20 according to cell selection criteria or cell reselection criteria and has camped on to that cell. The fact that the UE 1 is outside the coverage of the RAN node 2 or the NG-RAN 20 may mean that none of the cells provided by the RAN node 2 or the NG-RAN 20 is a suitable cell for the UE 1 to camp on.

In a first implementation, the first configuration parameter(s) may explicitly specify the carrier frequency of the primary carrier and may explicitly specify the carrier frequency of the secondary carrier. The first configuration parameter(s) may explicitly specify the carrier frequency of each of two or more secondary carriers.

In a second implementation, the first configuration parameter(s) may specify the carrier frequency of the primary carrier and may provide a plurality of candidate carrier frequencies for the secondary carrier. In this case, when the UE 1 is outside the coverage of the RAN node 2 (or the NG-RAN 20), the UE 1 may autonomously select the secondary carrier from the plurality of candidate carriers.

In a third implementation, the first configuration parameter(s) may provide a plurality of candidate carrier frequencies for the primary carrier and a plurality of candidate carrier frequencies for the secondary carrier. In this case, when the UE 1 is outside the coverage of the RAN node 2 (or the NG-RAN 20), the UE 1 may autonomously select the primary carrier from its candidate carriers and autonomously select the secondary carrier from its candidate carriers.

The plurality of candidate carrier frequencies of the primary carrier may be the same or common to the plurality of candidate carrier frequencies of the secondary carrier. In other words, the first configuration parameter(s) may provide multiple candidate sidelink carrier frequencies, each of which may be used as a primary carrier or a secondary carrier. The UE 1 may autonomously select the primary and secondary carriers from these multiple candidate carrier frequencies. The multiple candidate carrier frequencies that are common to the primary and secondary carriers may be multiple resource pools. In other words, the first configuration parameter(s) may be configurations of multiple resource pools.

The autonomous selection of the primary carrier in the third implementation described above, and the autonomous selection of the secondary carrier in the second and third implementations may be performed as follows. In one example, the UE 1 may randomly select or determine the primary carrier from a plurality of candidate carrier frequencies. Similarly, the UE 1 may randomly select or determine the secondary carrier from a plurality of candidate carrier frequencies.

In another example, the UE 1 may measure channel busy ratios (CBRs) of a plurality of candidate carrier frequencies. The UE 1 may select or determine the primary carrier by comparing the CBRs of the candidate carrier frequencies. Specifically, the UE 1 may select the carrier with the lowest CBR among the plurality of candidate carriers as the primary carrier. Alternatively, the UE 1 may select or determine the primary carrier from one or more candidate carrier frequencies whose CBR is below a threshold value. The UE 1 may select the secondary carrier in the same way.

In yet another example, the UE 1 may select or determine the primary carrier by comparing multiple candidate carrier frequencies in Sidelink Reference Signal Received Power (SL-RSRP). SL-RSRP measurements of the multiple candidate carrier frequencies may be performed by the UE 1 itself. Alternatively, the UE 1 may receive SL-RSRP measurement results from one or more other UEs.

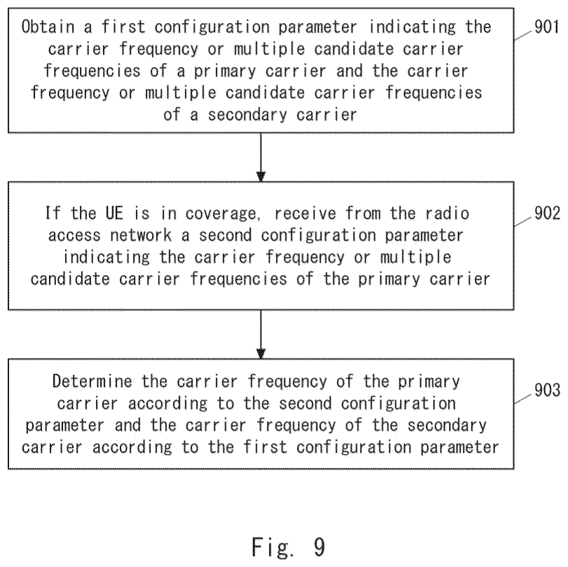

FIG. 9 shows an example of the operation of the UE 1 when the UE 1 is within the coverage of the RAN node 2 (or the NG-RAN 20). Step 901 is the same as step 801 in FIG. 8. In step 902, when the UE 1 is within the coverage of the RAN node 2 (or the NG-RAN 20), the UE 1 receives from the RAN node 2 (or the NG-RAN 20) a second configuration parameter(s) indicating the carrier frequency or a plurality of candidate carrier frequencies of the primary carrier. The UE 1 may receive the second configuration parameter from the RAN node 2 in non-UE specific signaling (e.g., system information broadcast) or UE specific signaling (e.g., RRC signaling).

In step 903, the UE 1 selects or determines the carrier frequency of the primary carrier according to the second configuration parameter. The second configuration parameter may explicitly specify the carrier frequency of the primary carrier. Alternatively, the second configuration parameter may provide a plurality of candidate carrier frequencies for the primary carrier. In this case, the UE 1 autonomously selects the primary carrier from the plurality of candidate carrier frequencies. The selection of the carrier frequency of the primary carrier by the UE 1 may be similar to any of the methods described with reference to FIG. 8. Specifically, the UE 1 may randomly select or determine the primary carrier from the plurality of candidate carrier frequencies. Alternatively, the UE 1 may select or determine the primary carrier by comparing CBRs or SL-RSRPs of the plurality of candidate carrier frequencies.

In addition, the UE 1 selects or determines the carrier frequency of the secondary carrier according to the (preconfigured) first configuration parameter(s). The selection of the carrier frequency of the secondary carrier based on the first configuration parameter may be similar to that described with reference to FIG. 8.

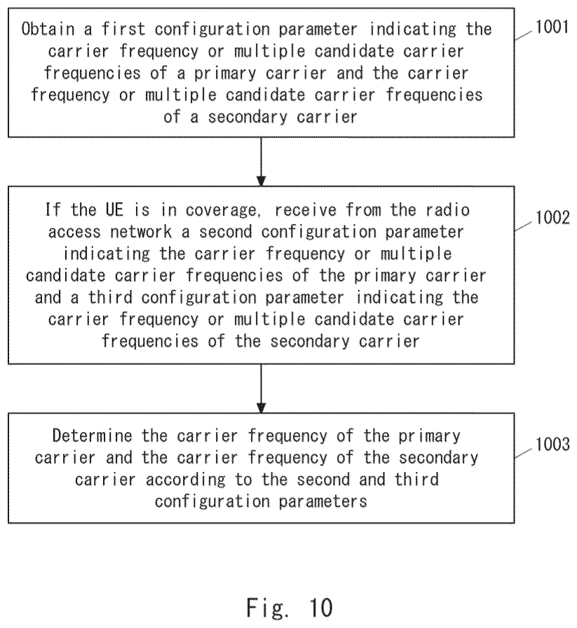

FIG. 10 shows another example of the operation of the UE 1 when the UE 1 is within the coverage of the RAN node 2 (or the NG-RAN 20). In the example in FIG. 10, when the UE 1 is in coverage, the RAN node 2 (or the NG-RAN 20) further provides a third configuration parameter(s) indicating the carrier frequency or a plurality of candidate carrier frequencies of the secondary carrier.

Step 1001 is the same as step 801 in FIG. 8 and step 901 in FIG. 9. As in step 902 of FIG. 9, in step 1002, when the UE 1 is within the coverage of the RAN node 2 (or the NG-RAN 20), the UE 1 receives from the RAN node 2 (or the NG-RAN 20) a second configuration parameter(s) indicating the carrier frequency or a plurality of candidate carrier frequencies of the primary carrier. In addition, the UE 1 receives from the RAN node 2 (or the NG-RAN 20) a third configuration parameter(s) indicating the carrier frequency or a plurality of candidate carrier frequencies of the secondary carrier. The UE 1 may receive the second and third configuration parameters from the RAN node 2 in non-UE specific signaling (e.g., system information broadcast) or UE specific signaling (e.g., RRC signaling).

In step 1003, the UE 1 selects or determines the carrier frequency of the primary carrier according to the second configuration parameter. This operation may be the same as that described in step 903 of FIG. 9.

In addition, the UE 1 selects or determines the carrier frequency of the secondary carrier according to the third configuration parameter. The third configuration parameter may explicitly specify the carrier frequency of the secondary carrier. Alternatively, the second configuration parameter may provide a plurality of candidate carrier frequencies for the secondary carrier. In this case, the UE 1 autonomously selects the secondary carrier from the plurality of candidate carrier frequencies. The selection of the carrier frequency of the secondary carrier by the UE 1 may be similar to any of the methods described with reference to FIG. 8. Specifically, the UE 1 may randomly select or determine the secondary carrier from the plurality of candidate carrier frequencies. Alternatively, the UE 1 may select or determine the secondary carrier by comparing CBRs or SL-RSRPs of the plurality of candidate carrier frequencies.

As described above, the second configuration parameter may specify multiple candidate carrier frequencies for the primary carrier and the third configuration parameter may specify multiple candidate carrier frequencies for the secondary carrier. In this case, the multiple candidate carrier frequencies of the primary carrier may be identical or common to the multiple candidate carrier frequencies of the secondary carrier. The UE 1 may select the primary and secondary carriers from the common multiple candidate carrier frequencies. The multiple candidate carrier frequencies that are common to the primary and secondary carriers may be multiple resource pools. In other words, the second and third configuration parameters may be configurations of multiple resource pools.

The operations of the UE 1 described with reference to FIGS. 8 to 10 allow the UE 1 to determine the primary and secondary carriers for sidelink communication, when in-coverage, out-of-coverage, or both.

### Third Example Embodiment

This example embodiment provides improvements related to carrier aggregation in the NR sidelink. Specifically, this example embodiment provides signaling between UEs for sidelink carrier aggregation. The configuration and operation of a radio communication system and network elements (or apparatuses, nodes, devices, or network functions) in this example embodiment may be the same as in the examples described with reference to FIGS. 1 to 6.

A UE 1 (e.g., UE 1A) transmits to a peer UE 1 (e.g., UE 1B) a control message indicating the addition, modification, or release of a secondary carrier. The control message may be a PC5-RRC message.

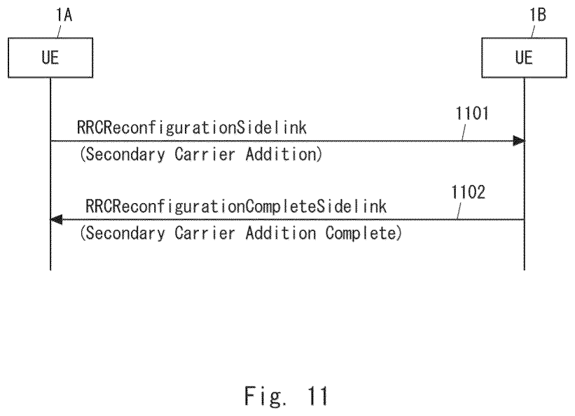

FIG. 11 shows an example of signaling between UEs regarding the addition of a secondary carrier. In step 1101, the UE 1A transmits an RRCReconfigurationSidelink message. The message indicates a secondary carrier addition. The message may contain a secondary carrier addition request. The message may contain a secondary carrier configuration. The secondary carrier configuration may include an indication of the secondary carrier (or an indication of the carrier frequency of the secondary carrier).

If the UE 1B can accept all the configurations contained in the RRCReconfigurationSidelink message, including the addition of the secondary carrier, the UE 1B applies these configurations. In step 1102, the UE 1B then sends an RRCReconfiguration CompleteSidelink message to the UE 1A. Conversely, the UE 1B sends an RRCReconfigurationFailureSidelink message to the UE 1A if it cannot accept the configurations (or parts thereof) contained in the RRCReconfigurationSidelink message. For example, if the UE 1B does not support the carrier frequency of the secondary carrier specified in the secondary carrier configuration, or does not support the combination of the carrier frequency of the primary carrier and the carrier frequency of the secondary carrier specified in the secondary carrier configuration, the UE 1B may respond to the UE 1A with an RRCReconfiguration FailureSidelink message.

In addition to the PC5-RRC message to add a secondary carrier shown in FIG. 11, the UE 1A may transmit a control message, control information, or a control command to the UE 1B to activate or deactivate the configured secondary carrier. The control message, information, or command may be a MAC CE (e.g., Activation/Deactivation MAC CE).

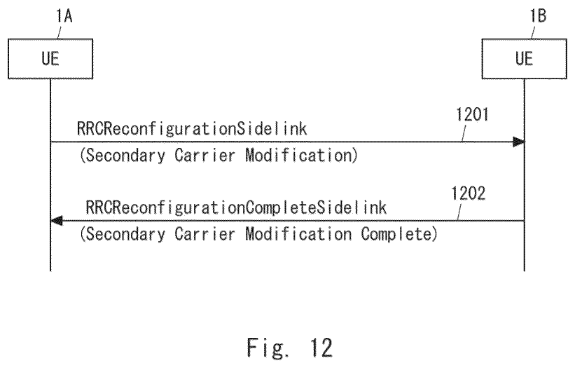

FIG. 12 shows an example of signaling between UEs regarding the modification of a secondary carrier. In step 1201, the UE 1A transmits an RRCReconfigurationSidelink message. The message indicates a secondary carrier modification. The message may contain a secondary carrier modification request. The message may contain a modified or updated secondary carrier configuration. The modified or updated secondary carrier configuration may indicate that the carrier frequency of the secondary carrier is to be changed.

If the UE 1B can accept all the configurations contained in the RRCReconfigurationSidelink message, including the modification of the secondary carrier, the UE 1B applies these configurations. In step 1202, the UE 1B then sends an RRCReconfiguration CompleteSidelink message to the UE 1A. Conversely, the UE 1B sends an RRCReconfigurationFailureSidelink message to the UE 1A if it cannot accept the configurations (or parts thereof) contained in the RRCReconfigurationSidelink message. For example, if the UE 1B does not support the modified carrier frequency of the secondary carrier, or does not support the combination of the carrier frequency of the primary carrier and the modified carrier frequency of the secondary carrier, the UE 1B may respond to the UE 1A with an RRCReconfiguration FailureSidelink message.

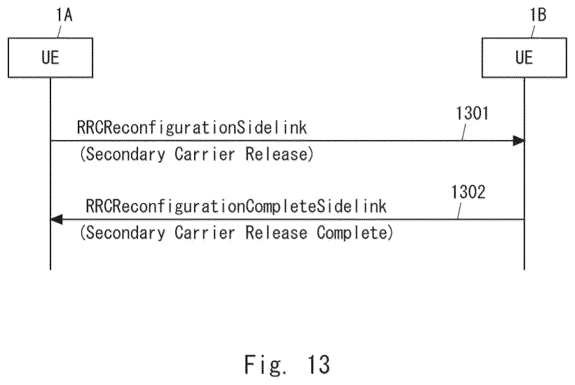

FIG. 13 shows an example of signaling between UEs regarding the release of a secondary carrier. In step 1301, the UE 1A transmits an RRCReconfigurationSidelink message. The message indicates a secondary carrier release. The message may contain a secondary carrier release request. The message may contain an indication (e.g., identifier or index) of the secondary carrier to be released.

If the UE 1B can accept all the configurations contained in the RRCReconfigurationSidelink message, including the release of the secondary carrier, the UE 1B applies these configurations. In step 1202, the UE 1B then sends an RRCReconfiguration CompleteSidelink message to the UE 1A. Conversely, the UE 1B sends an RRCReconfigurationFailureSidelink message to the UE 1A if it cannot accept the configurations (or parts thereof) contained in the RRCReconfigurationSidelink message. For example, the UE 1B may respond to the UE 1A with an RRCReconfigurationFailureSidelink message if it cannot accept the release of the secondary carrier.

The operations of the UEs 1A and 1B described with reference to FIGS. 11 to 13 allow these UEs to add, modify, and release a secondary carrier for the NR sidelink.

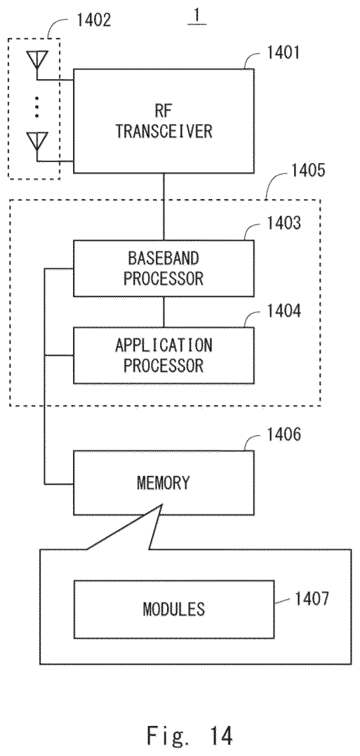

Examples of configurations of the UE 1, the RAN node 2, core network nodes such as the AMF 41, and the V2X application server 61 according to the plurality of example embodiments described above are provided below. FIG. 14 is a block diagram showing an example configuration of the UE 1. A radio frequency (RF) transceiver 1401 performs analog RF signal processing to communicate with other UEs and the RAN node 2. The RF transceiver 1401 may include a plurality of transceivers. The analog RF signal processing performed by the RF transceiver 1401 includes frequency up-conversion, frequency down-conversion, and amplification. The RF transceiver 1401 is coupled to an antenna array 1402 and a baseband processor 1403. The RF transceiver 1401 receives modulated symbol data (or OFDM symbol data) from the baseband processor 1403, generates a transmission RF signal, and supplies the transmission RF signal to the antenna array 1402. The RF transceiver 1401 generates a baseband reception signal based on a reception RF signal received by the antenna array 1402 and supplies the baseband reception signal to the baseband processor 1403. The RF transceiver 1401 may include an analog beamformer circuit for beamforming. The analog beamformer circuit includes, for example, a plurality of phase shifters and a plurality of power amplifiers.

The baseband processor 1403 performs digital baseband signal processing (data-plane processing) and control-plane processing for wireless communication. The digital baseband signal processing includes (a) data compression/decompression, (b) data segmentation/concatenation, (c) transmission format (transmission frame) composition/decomposition, (d) channel encoding/decoding, (e) modulation (i.e., symbol mapping)/demodulation, and (f) Inverse Fast Fourier Transform (IFFT) generation of OFDM symbol data (baseband OFDM signal). On the other hand, the control-plane processing includes communication management of layer 1 (e.g., transmission power control), layer 2 (e.g., radio resource management, and hybrid automatic repeat request (HARQ) processing), and layer 3 (e.g., signaling regarding attach, mobility, and call management).

For example, the digital baseband signal processing performed by the baseband processor 1403 may include signal processing in the Service Data Adaptation Protocol (SDAP) layer, Packet Data Convergence Protocol (PDCP) layer, Radio Link Control (RLC) layer, Medium Access Control (MAC) layer, and Physical (PHY) layer. The control-plane processing performed by the baseband processor 1403 may include processing of Non-Access Stratum (NAS) protocols, Radio Resource Control (RRC) protocols, MAC Control Elements (CEs), and Downlink Control Information (DCIs). The control-plane processing may include processing of PC5-S signaling and PC5-RRC signaling.

The baseband processor 1403 may perform Multiple Input Multiple Output (MIMO) encoding and precoding for beamforming.

The baseband processor 1403 may include a modem processor (e.g., Digital Signal Processor (DSP)) that performs the digital baseband signal processing and a protocol stack processor (e.g., Central Processing Unit (CPU) or Micro Processing Unit (MPU)) that performs the control-plane processing. In this case, the protocol stack processor performing the control-plane processing may be integrated with an application processor 1404 described later.

The application processor 1404 may also be referred to as a CPU, an MPU, a microprocessor, or a processor core. The application processor 1404 may include a plurality of processors (processor cores). The application processor 1404 loads a system software program (Operating System (OS)) and various application programs (e.g., a voice call application, a web browser, a mailer, a camera operation application, a music player application) from a memory 1406 or from another memory (not shown) and executes these programs, thereby providing various functions of the UE 1.

In some implementations, as represented by the dashed line (1405) in FIG. 14, the baseband processor 1403 and the application processor 1404 may be integrated on a single chip. In other words, the baseband processor 1403 and the application processor 1404 may be implemented in a single System on Chip (SoC) device 1405. A SoC device may be referred to as a system Large Scale Integration (LSI) or a chipset.

The memory 1406 is a volatile memory or a non-volatile memory, or a combination thereof. The memory 1406 may include a plurality of physically independent memory devices. The volatile memory is, for example, Static Random Access Memory (SRAM), Dynamic RAM (DRAM), or a combination thereof. The non-volatile memory may be a Mask Read Only Memory (MROM), an Electrically Erasable Programmable ROM (EEPROM), a flash memory, a hard disk drive, or any combination thereof. The memory 1406 may include, for example, an external memory device that can be accessed by the baseband processor 1403, the application processor 1404, or the SoC 1405. The memory 1406 may include an internal memory device that is integrated into the baseband processor 1403, the application processor 1404, or the SoC 1405. Further, the memory 1406 may include a memory in a Universal Integrated Circuit Card (UICC).

The memory 1406 may store one or more software modules (computer programs) 1407 including instructions and data for processing by the UE 1 described in the above example embodiments. In some implementations, the baseband processor 1403 or the application processor 1404 may load the software module(s) 1407 from the memory 1406 and execute the loaded software module(s) 1407, thereby performing the processing of the UE 1 described in the above example embodiments with reference to the drawings.

The control-plane processing and operations performed by the UE 1 described in the above example embodiments can be achieved by elements other than the RF transceiver 1401 and the antenna array 1402, i.e., achieved by the memory 1406, which stores the software module(s) 1407, and one or both of the baseband processor 1403 and the application processor 1404.

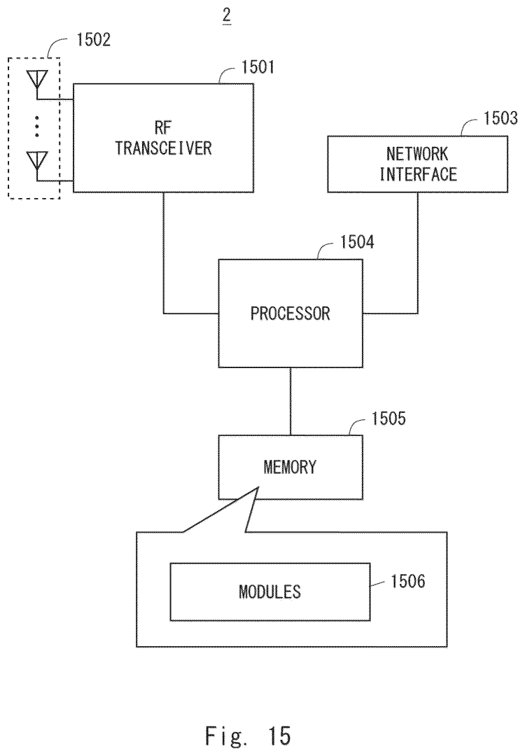

FIG. 15 is a block diagram showing an example configuration of the RAN node 2 according to the example embodiments described above. Referring to FIG. 15, the RAN node 2 includes a Radio Frequency transceiver 1501, a network interface 1503, a processor 1504, and a memory 1505. The RF transceiver 1501 performs analog RF signal processing to communicate with UEs 1 and other UEs. The RF transceiver 1501 may include a plurality of transceivers. The RF transceiver 1501 is coupled to an antenna array 1502 and the processor 1504. The RF transceiver 1501 receives modulated symbol data from the processor 1504, generates a transmission RF signal, and supplies the transmission RF signal to the antenna array 1502. The RF transceiver 1501 generates a baseband reception signal based on a reception RF signal received by the antenna array 1502 and supplies the baseband reception signal to the processor 1504. The RF transceiver 1501 may include an analog beamformer circuit for beamforming. The analog beamformer circuit includes, for example, a plurality of phase shifters and a plurality of power amplifiers.

The network interface 1503 is used to communicate with network nodes (e.g., other RAN nodes, and control and transfer nodes in the core network). The network interface 1503 may include, for example, a Network Interface Card (NIC) that complies with the IEEE 802.3 series.

The processor 1504 performs digital baseband signal processing (data-plane processing) and control-plane processing for wireless communication. The processor 1504 may include a plurality of processors. For example, the processor 1504 may include a modem processor (e.g., Digital Signal Processor (DSP)) for performing the digital baseband signal processing and a protocol stack processor (e.g., Central Processing Unit (CPU) or Micro Processing Unit (MPU)) for performing the control-plane processing. The processor 1504 may include a digital beamformer module for beamforming. The digital beamformer module may include a Multiple Input Multiple Output (MIMO) encoder and precoder.

The memory 1505 consists of a combination of a volatile memory and a non-volatile memory. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 1505 may include a storage located away from the processor 1504. In this case, the processor 1504 may access the memory 1505 through the network interface 1503 or another I/O interface.

The memory 1505 may store one or more software modules (computer programs) 1506 including instructions and data for performing processing by the RAN node 2 described in the above example embodiments. In some implementations, the processor 1504 may be configured to load and execute the software module(s) 1506 from the memory 1505, thereby performing the processing of the RAN node 2 described in the above example embodiments.

If the RAN node 2 is a Central Unit (CU) (e.g., gNB-CU) or a CU Control Plane Unit (CU-CP) (e.g., gNB-CU-CP), the RAN node 2 does not need to include the RF transceiver 1501 (and antenna array 1502).

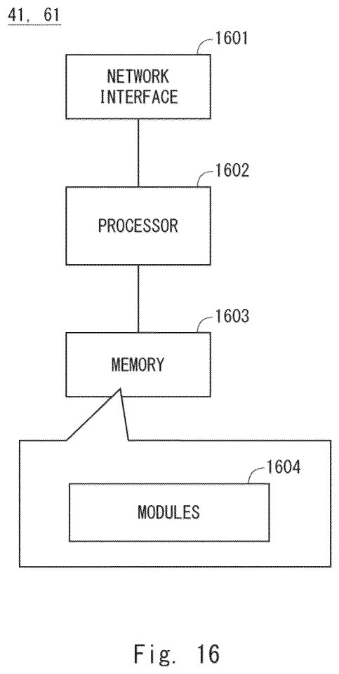

FIG. 16 shows an example configuration of the AMF 41. Other core network nodes in the 5GC 40 and the V2X application server 61 may also have a configuration similar to that shown in FIG. 16. For example, the network interface 1601 is used to communicate with other network functions (NFs) or nodes. For example, the network interface 1601 may include a network interface card (NIC) that is compliant with the IEEE 802.3 series.

The processor 1602 may be, for example, a microprocessor, a Micro Processing Unit (MPU), or a Central Processing Unit (CPU). The processor 1602 may include a plurality of processors.

The memory 1603 consists of a combination of a volatile memory and a non-volatile memory. The memory 1603 may include multiple physically independent memory devices. The volatile memory is, for example, a Static Random Access Memory (SRAM), a Dynamic RAM (DRAM), or a combination thereof. The non-volatile memory may be a Mask Read Only Memory (MROM), an Electrically Erasable Programmable ROM (EEPROM), a flash memory, or a hard disk drive, or any combination thereof. The memory 1603 may include a storage located away from the processor 1602. In this case, the processor 1602 may access the memory 1603 through the network interface 1601 or another I/O interface.

The memory 1603 may store one or more software modules (computer programs) 1604 including instructions and data for performing processing by the AMF 41 described in the above example embodiments. In some implementations, the processor 1602 may be configured to load and execute the software module(s) 1604 from the memory 1603, thereby performing the processing of the AMF 41 described in the above example embodiments.

As described using FIGS. 14, 15, and 16, each of the processors of the UE 1, the RAN node 2, the core network nodes such as the AMF 41, and the V2X application server 61 according to the example embodiments described above can execute one or more programs, containing a set of instructions, to cause a computer to perform an algorithm described with reference to the drawings. Each of these programs contains a set of instructions (or software codes) that, when loaded into a computer, causes the computer to perform one or more of the functions described in the example embodiments. Each of these programs may be stored in a non-transitory computer readable medium or a tangible storage medium. By way of example, and not limitation, non-transitory computer readable media or tangible storage media can include a random-access memory (RAM), a read-only memory (ROM), a flash memory, a solid-state drive (SSD) or other memory technologies, CD-ROM, digital versatile disk (DVD), Blu-ray (registered mark) disc or other optical disk storage, magnetic cassettes, magnetic tape, magnetic disk storage or other magnetic storage devices. Each program may be transmitted on a transitory computer readable medium or a communication medium. By way of example, and not limitation, transitory computer readable media or communication media can include electrical, optical, acoustical, or other form of propagated signals.

The example embodiments described above are merely examples of applications of the technical ideas of the inventor. These technical ideas are not limited to the above-described example embodiments, and various modifications may be made thereto.

For example, the whole or part of the example embodiments disclosed above can be described as, but not limited to, the following supplementary notes.

### Supplementary Note 1

A radio terminal comprising:
at least one radio transceiver; and
at least one processor coupled to the at least one radio transceiver and configured to:
   perform sidelink communication with a peer radio terminal on a primary carrier and a secondary carrier; and
   use the primary carrier without using the secondary carrier to transmit control plane data belonging to a first type of sidelink signaling radio bearer and control plane data belonging to a second type of sidelink signaling radio bearer, wherein
the first type of sidelink signaling radio bearer is used to transmit an unsecured upper layer message, and
the second type of sidelink signaling radio bearer is used to transmit an upper layer message for establishing security for a unicast link for the sidelink communication.

### Supplementary Note 2

The radio terminal according to Supplementary Note 1, wherein the upper layer message is a PC5 Signalling (PC5-S) message.

### Supplementary Note 3

The radio terminal according to Supplementary Note 1 or 2, wherein
the first type of sidelink signalling radio bearer is a Sidelink Signalling Radio Bearer 0 (SL-SRB0), and
the second type of sidelink signalling radio bearer is a Sidelink Signalling Radio Bearer 1 (SL-SRB1).

### Supplementary Note 4

The radio terminal according to any one of Supplementary Notes 1 to 3, wherein the at least one processor is configured to provide a Medium Access Control (MAC) entity,
wherein the MAC entity is configured to include, in one or more MAC Protocol Data Units (PDUs) to be transmitted on the primary carrier, data of a logical channel associated with the first type of sidelink signaling radio bearer and data of a logical channel associated with the second type of sidelink signaling radio bearer.

### Supplementary Note 5

The radio terminal according to any one of Supplementary Notes 1 to 4, wherein the at least one processor is configured to use the primary carrier without using the secondary carrier to transmit control plane data belonging to a third type of sidelink signaling radio bearer,
wherein the third type of sidelink signaling radio bearer is used to transmit an upper layer message after the security has been established.

### Supplementary Note 6

The radio terminal according to Supplementary Note 5, wherein the third type of sidelink signaling radio bearer is a Sidelink Signalling Radio Bearer 2 (SL-SRB2).

### Supplementary Note 7

The radio terminal according to Supplementary Note 5 or 6, wherein the at least one processor is configured to use the primary carrier without using the secondary carrier to transmit control plane data belonging to a fourth type of sidelink signaling radio bearer, wherein
the fourth type of sidelink signaling radio bearer is used to transmit a PC5 Radio Resource Control (PC5-RRC) message after the security has been established.

### Supplementary Note 8

The radio terminal according to Supplementary Note 7, wherein the fourth type of sidelink signaling radio bearer is a Sidelink Signalling Radio Bearer 3 (SL-SRB3).

### Supplementary Note 9

The radio terminal according to any one of Supplementary Notes 1 to 8, wherein the at least one processor is configured to use the secondary carrier for transmission of user data belonging to a sidelink data radio bearer, but not to use the secondary carrier for transmission of control plane data belonging to any sidelink signaling radio bearer.

### Supplementary Note 10

The radio terminal according to any one of Supplementary Notes 1 to 9, wherein the primary carrier is included in a licensed spectrum of a radio access network node to which the radio terminal is connected, and the secondary carrier is included in an unlicensed spectrum.

### Supplementary Note 11

The radio terminal according to any one of Supplementary Notes 1 to 9, further comprising a memory configured to store a first configuration parameter indicating a carrier frequency or a plurality of candidate carrier frequencies of the primary carrier and a carrier frequency or a plurality of candidate carrier frequencies of the secondary carrier, wherein
the at least one processor is configured to determine a carrier frequency of the primary carrier and a carrier frequency of the secondary carrier according to the first configuration parameter stored in the memory when the radio terminal is out of coverage of a radio access network.

### Supplementary Note 12

The radio terminal according to Supplementary Note 11, wherein the memory is a non-volatile memory in a Mobile Equipment (ME), or a Universal Subscriber Identity Module (USIM).

### Supplementary Note 13

The radio terminal according to Supplementary Note 11 or 12, wherein the first configuration parameter is provided to the radio terminal by a core network node or a vehicle-to-everything (V2X) application server.

### Supplementary Note 14

The radio terminal according to any one of Supplementary Notes 11 to 13, wherein the at least one processor is configured to, when the radio terminal is within coverage of a radio access network, receive from the radio access network a second configuration parameter indicating a carrier frequency or a plurality of candidate carrier frequencies for the primary carrier, and determine a carrier frequency of the primary carrier according to the second configuration parameter.

### Supplementary Note 15

The radio terminal according to Supplementary Note 14, wherein the at least one processor is configured to determine a carrier frequency of the secondary carrier according to the first configuration parameter when the radio terminal is in the coverage of the radio access network.

### Supplementary Note 16

The radio terminal according to Supplementary Note 14, wherein the at least one processor is configured to, when the radio terminal is within the coverage of the radio access network, receive from the radio access network a third configuration parameter indicating a carrier frequency or a plurality of candidate carrier frequencies for the secondary carrier, and determine a carrier frequency of the secondary carrier according to the third configuration parameter.

### Supplementary Note 17

The radio terminal according to any one of Supplementary Notes 1 to 16, wherein the at least one processor is configured to transmit to the peer radio terminal a PC5 Radio Resource Control (PC5-RRC) message indicating addition, modification, or release of the secondary carrier.

### Supplementary Note 18

A method performed by a radio terminal, the method comprising:
performing sidelink communication with a peer radio terminal on a primary carrier and a secondary carrier; and
using the primary carrier without using the secondary carrier to transmit control plane data belonging to a first type of sidelink signaling radio bearer and control plane data belonging to a second type of sidelink signaling radio bearer, wherein
the first type of sidelink signaling radio bearer is used to transmit an unsecured upper layer message, and
the second type of sidelink signaling radio bearer is used to transmit an upper layer message for establishing security for a unicast link for the sidelink communication.

### Supplementary Note 19

A program for causing a computer to perform a method for a radio terminal, the method comprising:
performing sidelink communication with a peer radio terminal on a primary carrier and a secondary carrier; and
using the primary carrier without using the secondary carrier to transmit control plane data belonging to a first type of sidelink signaling radio bearer and control plane data belonging to a second type of sidelink signaling radio bearer, wherein
the first type of sidelink signaling radio bearer is used to transmit an unsecured upper layer message, and
the second type of sidelink signaling radio bearer is used to transmit an upper layer message for establishing security for a unicast link for the sidelink communication.

This application is based upon and claims the benefit of priority from Japanese Patent Application No. 2022-038087, filed on Mar. 11, 2022, the disclosure of which is incorporated herein in its entirety by reference.

### REFERENCE SIGNS LIST

1A, 1B UE
2 RAN node
21 Cell
41 AMF
44 PCF
61 V2X application server
103 Inter-UE direct interface
1403 Baseband processor
1404 Application processor
1406 Memory
1407 Modules
1504 Processor
1505 Memory
1506 Modules
1602 Processor
1603 Memory
1604 Modules

What is claimed is:

1. A radio terminal comprising:
at least one radio transceiver; and
at least one processor coupled to the at least one radio transceiver and configured to:
perform sidelink communication with a peer radio terminal on a primary carrier and a secondary carrier; and
use the primary carrier without using the secondary carrier to transmit control plane data belonging to a first type of sidelink signaling radio bearer and control plane data belonging to a second type of sidelink signaling radio bearer, wherein
the first type of sidelink signaling radio bearer is used to transmit an unsecured upper layer message, and
the second type of sidelink signaling radio bearer is used to transmit an upper layer message for establishing security for a unicast link for the sidelink communication.

2. The radio terminal according to claim 1, wherein the upper layer message is a PC5 Signalling (PC5-S) message.

3. The radio terminal according to claim 1, wherein
the first type of sidelink signalling radio bearer is a Sidelink Signalling Radio Bearer 0 (SL-SRB0), and
the second type of sidelink signalling radio bearer is a Sidelink Signalling Radio Bearer 1 (SL-SRB1).

4. The radio terminal according to claim 1, wherein the at least one processor is configured to provide a Medium Access Control (MAC) entity,
wherein the MAC entity is configured to include, in one or more MAC Protocol Data Units (PDUs) to be transmitted on the primary carrier, data of a logical channel associated with the first type of sidelink signaling radio bearer and data of a logical channel associated with the second type of sidelink signaling radio bearer.

5. The radio terminal according to claim 1, wherein the at least one processor is configured to use the primary carrier without using the secondary carrier to transmit control plane data belonging to a third type of sidelink signaling radio bearer,
wherein the third type of sidelink signaling radio bearer is used to transmit an upper layer message after the security has been established.

6. The radio terminal according to claim 5, wherein the third type of sidelink signaling radio bearer is a Sidelink Signalling Radio Bearer 2 (SL-SRB2).

7. The radio terminal according to claim 5, wherein the at least one processor is configured to use the primary carrier without using the secondary carrier to transmit control plane data belonging to a fourth type of sidelink signaling radio bearer, wherein
the fourth type of sidelink signaling radio bearer is used to transmit a PC5 Radio Resource Control (PC5-RRC) message after the security has been established.

8. The radio terminal according to claim 7, wherein the fourth type of sidelink signaling radio bearer is a Sidelink Signalling Radio Bearer 3 (SL-SRB3).

9. The radio terminal according to claim 1, wherein the at least one processor is configured to use the secondary carrier for transmission of user data belonging to a sidelink data radio bearer, but not to use the secondary carrier for transmission of control plane data belonging to any sidelink signaling radio bearer.

10. The radio terminal according to claim 1, wherein the primary carrier is included in a licensed spectrum of a radio access network node to which the radio terminal is connected, and the secondary carrier is included in an unlicensed spectrum.

11. The radio terminal according to claim 1, further comprising a memory configured to store a first configuration parameter indicating a carrier frequency or a plurality of candidate carrier frequencies of the primary carrier and a carrier frequency or a plurality of candidate carrier frequencies of the secondary carrier, wherein
the at least one processor is configured to determine a carrier frequency of the primary carrier and a carrier frequency of the secondary carrier according to the first configuration parameter stored in the memory when the radio terminal is out of coverage of a radio access network.

12. The radio terminal according to claim 11, wherein the memory is a non-volatile memory in a Mobile Equipment (ME), or a Universal Subscriber Identity Module (USIM).

13. The radio terminal according to claim 11, wherein the first configuration parameter is provided to the radio terminal by a core network node or a vehicle-to-everything (V2X) application server.

14. The radio terminal according to claim 11, wherein the at least one processor is configured to, when the radio terminal is within coverage of a radio access network, receive from the radio access network a second configuration parameter indicating a carrier frequency or a plurality of candidate carrier frequencies for the primary carrier, and determine a carrier frequency of the primary carrier according to the second configuration parameter.

15. The radio terminal according to claim 14, wherein the at least one processor is configured to determine a carrier frequency of the secondary carrier according to the first configuration parameter when the radio terminal is in the coverage of the radio access network.

16. The radio terminal according to claim 14, wherein the at least one processor is configured to, when the radio terminal is within the coverage of the radio access network, receive from the radio access network a third configuration parameter indicating a carrier frequency or a plurality of candidate carrier frequencies for the secondary carrier, and determine a carrier frequency of the secondary carrier according to the third configuration parameter.

17. The radio terminal according to claim 1, wherein the at least one processor is configured to transmit to the peer radio terminal a PC5 Radio Resource Control (PC5-RRC) message indicating addition, modification, or release of the secondary carrier.

18. A method performed by a radio terminal, the method comprising:
performing sidelink communication with a peer radio terminal on a primary carrier and a secondary carrier; and
using the primary carrier without using the secondary carrier to transmit control plane data belonging to a first type of sidelink signaling radio bearer and control plane data belonging to a second type of sidelink signaling radio bearer, wherein
the first type of sidelink signaling radio bearer is used to transmit an unsecured upper layer message, and
the second type of sidelink signaling radio bearer is used to transmit an upper layer message for establishing security for a unicast link for the sidelink communication.

19. A non-transitory computer readable medium storing a program for causing a computer to perform a method for a radio terminal, the method comprising:
performing sidelink communication with a peer radio terminal on a primary carrier and a secondary carrier; and
using the primary carrier without using the secondary carrier to transmit control plane data belonging to a first type of sidelink signaling radio bearer and control plane data belonging to a second type of sidelink signaling radio bearer, wherein
the first type of sidelink signaling radio bearer is used to transmit an unsecured upper layer message, and
the second type of sidelink signaling radio bearer is used to transmit an upper layer message for establishing security for a unicast link for the sidelink communication.
